(19) United States
(12) Patent Application Publication
(10) Pub. No.: US 2020/0282470 A1
(43) Pub. Date: Sep. 10, 2020

(54) Pocket Hole Jig Swing Stop Measuring System

(71) Applicant: Mark A. Duginske, Merrill, WI (US)

(72) Inventor: Mark A. Duginske, Merrill, WI (US)

(21) Appl. No.: 16/812,049

(22) Filed: Mar. 6, 2020

Related U.S. Application Data
(60) Provisional application No. 62/814,517, filed on Mar. 6, 2019.

(51) Int. Cl. B23B 47/28

(52) U.S. Cl. CPC B23B 47/28

(57) ABSTRACT

Jigs, fixtures, and position stops for locating, aligning, guiding, and/or holding a workpiece on a woodworking machinery during a woodworking operation are described, as well as methods of making, modifying, and using jigs and fixtures.

### CROSS-REFERENCE TO RELATED APPLICATIONS

This application claims priority under 35 U.S.C. § 119 to U.S. Provisional Application No. 62/814,517 filed on Mar. 6, 2019, the entire contents of which are incorporated herein by reference.

### STATEMENT CONCERNING FEDERALLY SPONSORED RESEARCH OR DEVELOPMENT

Not applicable.

### FIELD OF THE INVENTION

This invention relates to jigs and fixtures for aligning, guiding, and/or holding a workpiece on woodworking machinery during a woodworking operation.

### BACKGROUND OF THE INVENTION

Woodworking machines utilize various means of positioning or securing a workpiece as it is cut, drilled, routed, or otherwise worked. As standard equipment, a pocket hole jig is not fitted with a stop system for measuring the workpiece location or for securing the workpiece in the desired location. A position stop helps establish a repeatable location of the workpiece boards in relationship to, for instance, a drill bit or a cutter. A flip stop or a swing stop, which is rotated out of the way when not in use, also helps to establish a consistent workpiece location. One benefit of this technique is that the edge of the board being drilled is accurately positioned. The accuracy of processing multiple pieces can be improved with use of a stop system.

One example support stop is described in U.S. Pat. No. 8,231,313 B2. The support stop is a two-piece device having a main body and a pivot arm. The pivot arm can be moved between a support position (shown in FIG. 14A) and a stop position (shown in FIG. 14B). The support stop, however, is configured such that it cannot be simultaneously used as a support and as a stop. Multiple support stops must be used and spaced apart to provide the discrete support and stop functionalities. For instance, a first support stop must be positioned closer to the jig to support the workpiece on the main body of the first support stop with the pivot arm in the support position, and a second support stop must be positioned beyond the first support to function as a stop to position the workpiece with use of the pivot arm in the stop position. And, when the support stop is in the stop position, it no longer acts to provide support for a workpiece.

### SUMMARY OF THE INVENTION

Jigs and fixtures for aligning and positioning a workpiece on woodworking machinery during a woodworking operation are described as well as methods for modifying and using jigs, fixtures, and position stops. In one embodiment, a T-slot mounted stop base has a groove in the middle to capture and support a swing stop assembly that moves out of the way when contacted with a workpiece. In another embodiment, a swing stop assembly is configured to function as both a support platform and a swing stop measuring device. In other embodiments, swing stop assemblies capable of use with pocket hole jigs and other woodworking tools are described. In further embodiments, swing stop position adaptors and measurement devices are disclosed. In further embodiments, the swing stop assemblies of this disclosure are designed to interface with the standard jigs and equipment without the need, for instance, to drill or fabricate.

The foregoing and other objects and advantages of the invention will appear in the detailed description that follows. In the description, reference is made to the accompanying drawings that illustrate the preferred embodiments of the invention.

### BRIEF DESCRIPTION OF THE DRAWINGS

FIG. 1A is a perspective view of a KREG K4 pocket hole jig 10 secured to a flat board 30 and an example swing stop assembly 22.

FIG. 1B is an enlarged perspective view of the swing stop assembly 22 shown in FIG. 1A positioned on an example track extrusion 20.

FIG. 1C is a perspective view of the swing stop assembly 22 shown in FIG. 1B.

FIG. 1D is an exploded view of an example swing arm 28 and an example rotation pin 50 lined up with a hole 33 in the swing arm 28.

FIG. 1E is an end view of an example T-slot extrusion 20 to which the swing stop assembly 22 may be attached.

FIG. 1F is an end view of an optional example T-slot track 21.

FIG. 2A is a perspective view of a KREG K4 pocket hole jig secured to a flat board and a pair of example swing stop assemblies 22.

FIG. 2B is an enlarged perspective view of the swing stop 22 shown in FIG. 2A positioned on the track extrusion 20 in a stand-by or support position.

FIG. 2C is an enlarged perspective view of the swing stop 22 in the shown in FIG. 2A positioned on the track extrusion 20 in an engaged or stop position.

FIG. 2D is an end view of the swing stop arm 28 rotated to the stand-by or support position.

FIG. 2E is an end view the swing stop arm 28 rotated to the engaged or stop position.

FIG. 2F is an end view of the table mounted extrusion 20.

FIG. 2G is an end view of an example Z-shaped extrusion 32.

FIG. 2H is an end view of the table-mounted extrusion 20 screwed to a support board 30, the Z-shaped extrusion 32, and of the swing stop positions shown with dotted lines.

FIG. 2I is an end view of the swing stop arm 28 shown in the positions illustrated in FIG. 2H.

FIG. 3A is a perspective view of a KREG K4 pocket hole jig 10 and a pair of example swing stop assemblies 22.

FIG. 3B is an enlarged perspective view of the swing stop assembly 22 shown in FIG. 3A removed from the track extrusion 20 and the swing stop arm 28 in the stand-by or support position.

FIG. 3C is a side view of the swing stop arm 28 in the stand-by or support position.

FIG. 3D is an enlarged perspective view of the swing stop assembly 22 shown in FIG. 3A removed from the track extrusion 20 and the swing stop arm 28 in the engaged or stop position.

FIG. 3E is a side view of the swing stop arm 28 in the engaged or stop position.

FIG. 4A is a perspective view of a KREG K4 pocket hole jig 10 and a pair of example swing stop assemblies 22.

FIG. 4B is an enlarged perspective view of the swing stop assembly 22 shown in FIG. 4A positioned on the track extrusion 20.

FIG. 4C is an enlarged perspective view of FIG. 4A of the U-shaped clamp on fixture 52.

FIG. 4D is a perspective view of a KREG K4 pocket hole 10 with a workpiece panel 26 positioned for drilling.

FIG. 4E is a perspective view from under the workpiece 26 engaged by two swing stop assemblies 22 that are secured to a T-slot track 20.

FIG. 5A is an exploded perspective view of the example U-shaped clamping fixture 52, the example vertical T-slot leg 54, the example L-shaped connector 60, the example T-slot extrusion track 20, and example swing stop assemblies 22.

FIG. 5B is an enlarged perspective view of a portion of the U-shaped fixture 52.

FIG. 5C is an exploded perspective view of the T-slot extrusion track 20, example tape measure 24, example swing stop Z-shaped extrusion 32, and the rectangular swing stop arm 28.

FIG. 5D is a perspective view of the L-shaped connector 60 that fits into the vertical T-slot leg 54 and the horizontal track 20.

FIG. 5E is an exploded perspective view of an example connector plate 64.

FIG. 6A is an exploded view of the U-shaped clamping fixture 52, the vertical T-slot leg 54, the L-shaped connector 60, the T-slot extrusion track 20, and the swing stop assemblies 22.

FIG. 6B is an enlarged perspective view of the rectangular U-shaped extrusion 52.

FIG. 6C is an enlarged perspective view of the T-slot track 54.

FIG. 6D is an exploded perspective view of the swing stop assembly 22.

FIG. 7A is a perspective view of a T-slot track 20 and an example slide stop assembly 69.

FIG. 7B is an enlarged perspective view of the slide stop assembly 69 of FIG. 7A.

FIG. 7C is a perspective view of the slide stop assembly 69 of FIG. 7A removed from the T-slot track 20.

FIG. 7D is an exploded perspective view of the T-slot track 20, the L-shaped stop base 72, the oblong stop arm 73, and the pin 50 that fits into the stop arm base 72 and into the oblong slot 77 in the stop arm 73.

FIG. 7E is a side view illustration of three positions of the stop arm 73 represented with dotted lines.

FIG. 7F is an end view illustration of the workpiece 26 starting to make contact with the stop arm 73 when it is in the engaged position extending past the side edge of the T-slot extrusion 20.

FIG. 7G is an end view illustration of the workpiece 26 moving the stop arm 73 backwards with the opposite end of the stop arm 73 elevating above the track.

FIG. 7H is an end view illustration of the workpiece 26 moving the stop arm 73 backwards with the opposite end of the stop arm 73 elevating above the track 20 at a near vertical position.

FIG. 8A is a perspective view of a KREG K4 pocket hole jig 10 secured to a flat board 30 and a pair of example swing stop assemblies 76 incorporating a ruler point base 80.

FIG. 8B is an enlarged perspective view of the swing stop assemblies 76 shown in FIG. 8A.

FIG. 8C is a perspective view of the swing stop assemblies 76.

FIG. 8D is an enlarged perspective view of FIG. 8C illustrating the Z-shaped swing stop base 78 in contact with the cursor plate 80.

FIG. 8E is a perspective view of the cursor plate 80 of FIG. 8D removed from the Z-shaped swing stop base 78.

FIG. 8F is an end view of a portion of the swing stop assembly 76 positioned on the rectangular T-slot extrusion 20.

FIG. 9A is an exploded perspective view of the T-slot track extrusion 20, the ruler 24, the Z-shaped swing stop base extrusion 78, the cursor plate 80, the swing stop arm 28, and the tightening screw 38.

FIG. 9B is a perspective view of the Z-shaped swing stop base extrusion 78.

FIG. 9C is a perspective view of the cursor plate 80.

FIG. 9D is a perspective view of the swing stop arm 28.

FIG. 9E is a side view of the cursor plate 80.

FIG. 9F is a side view of the Z-shaped swing stop base extrusion 78.

FIG. 9G is an exploded perspective view of the rectangular T-slot extrusion 20 with an indentation 96 on both sides for accepting a tape measure 24.

FIG. 10A is a perspective view of a KREG K5 pocket hole jig 88 and a pair of example swing stop assemblies 90.

FIG. 10B is an enlarged perspective view of the swing stop assembly 90 shown in FIG. 10A.

FIG. 10C is a perspective view of the swing stop assembly 90 shown in FIG. 10A removed from the T-slot track.

FIG. 10D is a perspective view of the cursor plate 80 removed from the Z-shaped swing stop base member 92.

FIG. 10E is an end view of the T-slot extrusion 20 with the Z-shaped swing stop base extrusion 92, the cursor plate 80, and the swing stop arm 93.

FIG. 10F is an enlarged side view showing the V-grooves 84 of the Z-shaped swing stop base extrusion 92.

FIG. 11A is a perspective view of a KREG K5 pocket hole jig 88 with a clamp-on swing stop positioning system including two swing stop assemblies 90 that support the workpiece panel 26 at the same height as the jig floor 89 and provides an adjustable swing stop for repeatedly locating the end of the workpiece 26 in relationship to the drill guide hole.

FIG. 11B is an enlarged perspective view of FIG. 11A illustrating a spacer 65 that is located between the U-shaped fixture 52 and the vertical T-slot track 54 that extends to the bottom of the pocket hole jig.

FIG. 11C is an exploded perspective view of the U-shaped clamping fixture 52, the spacer 65, the vertical T-slot leg 54, the L-shaped connector 60, the T-slot extrusion track 20, and the swing stop assemblies 90.

### DETAILED DESCRIPTION OF THE PREFERRED EMBODIMENT

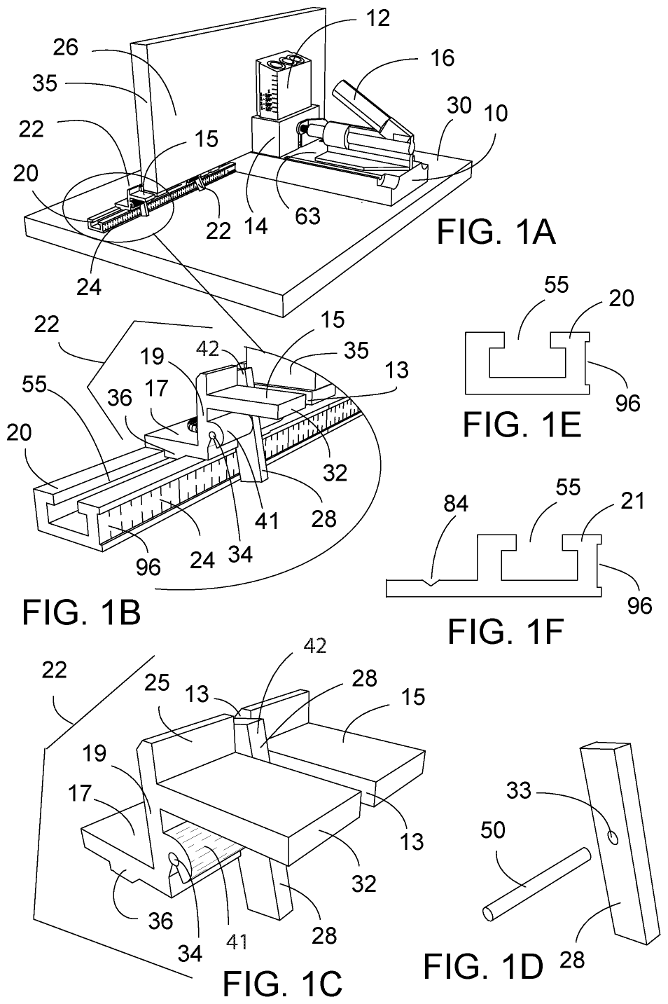

Embodiments of the invention are illustrated in extensive detail in the accompanying FIGS. 1-11, and as set forth above in the description of the accompanying FIGS. 1-11. As shown in the FIGS. 1-11, jigs, fixtures, and position stops for locating, aligning, guiding, and/or holding a workpiece on woodworking machinery during a woodworking operation are described, as well as methods of making, modifying, and using jigs and fixtures. In some embodiments, the example swing stop assemblies described herein provide a swing stop assembly that can simultaneously function as both a support for a workpiece and as a stop to accurately position the workpiece. The example swing stop assemblies include a swing stop arm that is configured to hang in a natural orientation that defines an engaged or stop position, whereat the swing stop assembly can both support the workpiece and simultaneously function as a stop for the workpiece. And, the swing stop arm is configured to be moveable by urging the swing stop arm away from the natural position (about the swing stop arm pivot axis), such as via engagement with a workpiece, to a non-engaged, stand-by or support position, such that the swing stop assembly readily provides a support surface for the workpiece that is generally coplanar with the woodwork device with which it is used (e.g., the floor of a jig). Furthermore, the example swing stop assemblies can be readily adapted to accommodate jigs of varying form factors and accessories, such as measurement devices.

FIG. 1A illustrates an example embodiment of a swing stop assembly 22 in accordance with an aspect of the invention. The illustration is a perspective view of a KREG K4 portable pocket hole jig 10 with the workpiece 26 secured in place with the jig clamp 16. The KREG K4 jig 10 is secured to a flat board that functions as an auxiliary table 30. The workpiece 26 is supported by the floor 63 of the KREG K4 portable pocket hole jig 10 and the other end of the workpiece 26 is supported by two swing stop assemblies 22. The top horizontal surface 15 of the swing stop assembly 22 is configured to be nominally level with the floor 63 of the KREG K4 pocket hole jig 10, thus establishing a generally level and coplanar support arrangement for the workpiece 26.

FIG. 1B is an enlargement of FIG. 1A illustrating the swing stop assembly 22 positioned on the T-track extrusion 20. A Z-shaped base extrusion 32 is the base of the swing stop assembly 22. The bottom horizontal surface 17 of the Z-shaped extrusion 32 contacts the T-slot track 20. A flange 36 on the bottom of the lower horizontal surface 17 of the Z-shaped base extrusion 32 fits into the T-slot track 20 opening 55. The Z-shaped base extrusion 32 has a slot 13 cut, or otherwise formed, in the middle of it. A rectangular swing stop arm 28 is located in the slot 13. The rectangular swing stop arm 28 hangs down from the middle of the Z-shaped extrusion 32 into a natural position (e.g., as urged by gravity when the swing stop assembly 22 is generally oriented as shown) and lines up with the ruler 24 on the edge of the T-slot track 20. Given that the bottom of the swing stop arm 28 is positioned proximate the ruler 24 located on the edge of the extrusion 20, the position of the swing stop arm 28, and hence an edge of the workpiece board 35, can be readily determined off the end of the Z-shaped extrusion 32. The swing stop assembly 22 supports the workpiece 26. The top of the swing stop 28 is in the engaged or stop position 42 and contacts the edge of the workpiece board 35 locating the workpiece 26 in relationship to the drill guide 12 for accurate and repeatable positioning of the pocket holes.

FIG. 1C is an enlarged illustration of the swing stop assembly 22 shown in FIG. 1B with the Z-shaped base extrusion 32 shown removed from the T-slot extrusion 20. The swing stop arm 28 is located in a slot 13 in the middle of the Z-shaped base extrusion 32. The middle portion 19 of the Z-shaped base extrusion 32 extends vertically connecting the bottom horizontal surface 17 with the top horizontal surface 15, which supports the workpiece 26. The middle portion 19 of the Z-shaped base extrusion 32 extends vertically past the upper horizontal leg 15 to create a fence 25. A round ridge 41 in the middle portion of the Z-shaped extrusion 19 contains a small slot or hole 34 in a middle leg that houses a round pin 50 that secures the rotatable swing stop arm 28 in place. FIG. 1D is an exploded view of the swing stop arm 28 and the rotation pin 50 lined up with the hole 33 in the swing stop arm 28. The pin 50 extends into the hole 34 defined by the round ridge 41 and through the hole 33 in the swing stop arm 28, thus pivotally coupling the swing stop arm 28 to the Z-shaped extrusion 32 about the aligned axes of the holes 33, 34. FIG. 1E is an end view of the T-slot extrusion 20 that the swing stop assembly 22 engaged. And, FIG. 1F is an end view of an optional T-slot track 21 with a flat extension and a V-shaped indentation 84, that can aid in installation by providing an area that, for instance, can be easily drilled to establish a hole for mounting the track 21 to an auxiliary table 30.

In the example arrangement shown, for instance, in FIGS. 1A, 1B, and 1C, the T-slot track 20 can be ¾ inch by ⅜ inch and attached (e.g., screwed) to the flat board 30. And, while the swing stop arm 28 is illustrated as generally rectangular in form, the swing stop arm may comprise a variety of form factors, such as include rounded ends or arcuate ends and surfaces. In use, one of the outside legs of the Z-shaped base extrusion 32 is horizontal and parallel to the floor 63 of the pocket hole jig 10, and can be positioned to support a workpiece board 35. The middle leg 19 of the Z-shaped base extrusion 32 extends past the horizontal surface 15 supporting the workpiece 26 and functions as a fence 25 to position and align the workpiece 26 with the drill guide block. In one embodiment, approximately the top quarter of the swing stop arm 28 extends upward through the slot 13 in the Z-shaped base extrusion 32. The swing stop arm 28 functions as a position stop when the end of the board rests against it. The swing stop arm 28 can also be rotated to a disengaged, stand-by or supporting position when the edge of the board is used to urge the swing stop arm 28 to rotate away from the natural stop position.

As shown in one embodiment, the swing stop assembly 22 includes a Z-shaped base extrusion 32 having a horizontal support surface 15, which generally defines a support surface area bounded by the outer perimeter of the support surface 15 (and extending, in one embodiment to bridge the slot 13). The Z-shaped base extrusion 32 and support surface 15 further define a width of about 1.125 inches in a first direction (e.g., in the axial direction defined by the pivotal movement of the swing stop arm 28). The swing stop arm 28 that is pivotally coupled to the Z-shaped base extrusion 32 defines an arm width in the first diction of about 0.125 inches, which is less than the base width. In other forms, the ratio of widths can be preferably defined such that the width of the swing stop arm 28 is less than the width of the support surface 15, therefore accommodating a dual functionality of supporting and stopping when the swing stop arm 28 is in the stop position.

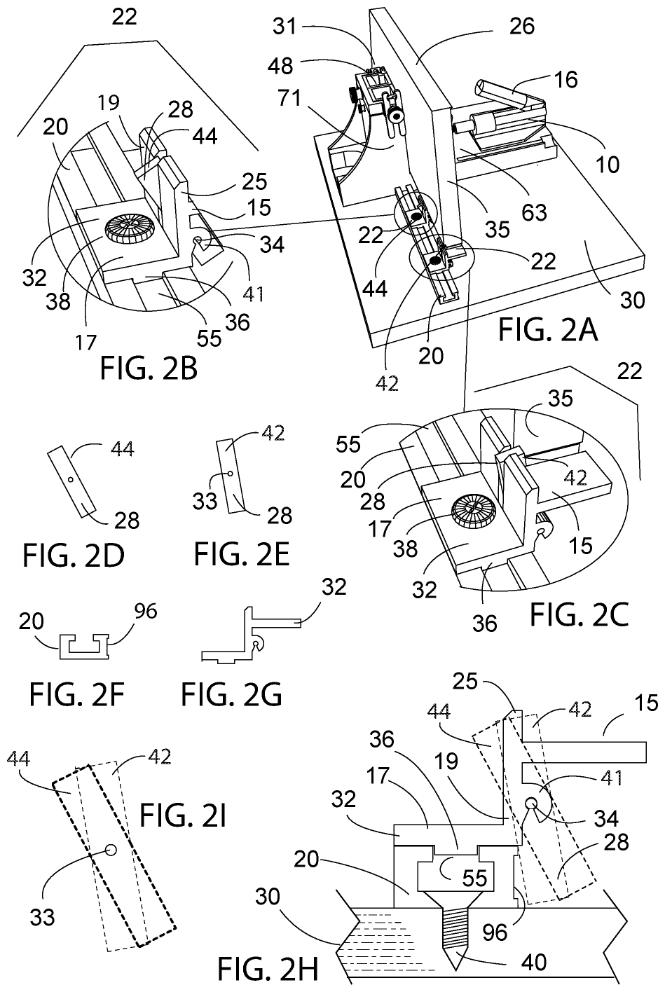

FIG. 2A is a perspective drawing of a KREG K4 pocket hole jig 10 secured to a flat board 30. The view is shown from the side of the jig 10 opposite the fast action toggle clamp handle 16. Two spacers 48 fill the drill guide compartment 31 in the drill guide tower 71. Secured to the T-slot track extrusion 20 are two example swing stop assemblies 22. FIG. 2B is an enlargement of the swing stop assembly 22 shown in FIG. 2A illustrating the swing stop assembly 22 that is secured to the T-slot track extrusion 20 with a machine screw 38. The swing stop assembly 22 nearest to the jig 10 supports the middle of the workpiece 26. The swing arm 28 is pushed or urged forward by the workpiece 26 and is in the stand-by position or support position 44. FIG. 2C is an enlargement of the swing stop assembly 22 positioned furthest from the jig 10 shown in FIG. 2A positioned on the T-slot track extrusion 20. The swing stop arm 28 is positioned in the natural, engaged or stop position 42 such that the swing stop arm 28 is hung or oriented to be in contact with the end of the workpiece board 35. That is, at least a portion of the swing stop arm 28 extends through an area of the support surface 15 (e.g., extends through an imaginary plane defined by the bounds of outer perimeter of the support surface 15 on both sides of the slot 13) upon which the workpiece 26 can engage when the swing stop arm 28 is urged to the support or standby position. When the swing stop assembly 22 is in the natural stop position, such that it is rotated into the opening slot 13 in the middle of the fence 25, the swing stop arm 28 is positioned near the ruler 24 located on the edge of the extrusion 20 and the workpiece 26 is in contact with the fence 25. The swing stop arm 28 is then positioned in the engaged or stop position in contact with the end 35 of the workpiece 26.

FIG. 2D illustrates the swing stop arm 28 rotated to the stand-by or support position 44. The hole 33 in the example swing stop arm 28 is located above or vertically offset from the transverse centerline so that the body of the swing stop arm 28 naturally hangs down vertically (e.g., generally upright as illustrated) by force of gravity. FIG. 2E illustrates the swing stop arm 28 rotated to the engaged position 42. FIG. 2F is an end view of the 0.375″ by 0.750″ T-slot extrusion 20 with and indentation 96 for engagement with a ruler 24. FIG. 2G is an end view of the Z-shaped extrusion 32.

FIG. 2H is an end view of the example table-mounted extrusion 20 screwed to a support board 30 with a flat head screw 40. To prevent the example swing stop assembly 22 from rotating, a flange 36 on the bottom leg 17 of the Z-shaped extrusion 32 fits into the T-slot opening 55 in the T-track 20. The flip stop arm 28 is illustrated with dotted lines to depict the relative positioning of an example support or stand-by position and an example stop or engaged position. The engage position 42 is illustrated with thinner dotted lines. The stand-by position 44 is illustrated with thicker dotted lines. The swing stop arm 28 is held in place by a long pin 50 (see FIG. 1D) that fits into a long hole 34 located in a circular ridge 41 of the middle member 19 of the Z-shaped stop base extrusion 32. FIG. 2I is an isolated view of the swing arm positions illustrated in FIG. 2H, again with the engage swing stop arm position 42 illustrated will a thinner dotted line and the swing stop arm stand-by position 44 illustrated with a thicker dotted line.

In the example arrangement shown, for instance, in FIGS. 2A, 2B, 2C, and 2H, the T-slot track 20 can be a ¾ inch by ⅜ inch extrusion attached to the flat board 30. Attached to the T-slot track extrusion 20 is a short Z-shaped base extrusion 32 with a small hole 34 in the middle leg 19. A slot 13 in the middle 19 of the Z-shaped base extrusion 32 accepts a rectangular swing stop arm 28. A pin 50 located in the small hole 34 of the Z-shaped base extrusion 32 extends through a hole 33 in the rectangular swing stop arm 28. One of the outside legs 15 of the Z-shaped base extrusion 32 is horizontal and parallel to the floor 63 of the pocket hole jig 10 and is positioned to support a workpiece board 26. The middle leg 19 of the Z-shaped base extrusion 32 extends past the horizontal surface 15 supporting the workpiece 26 and functions as a fence 25 to position and align the workpiece 26 with the drill guide block. In one embodiment, approximately the top quarter of the swing stop arm 28 extends upward through the slot 13 in the middle of the Z-shaped base extrusion 32. The rectangular swing stop arm 28 functions as a position stop when the end of the board rests against it, and the swing stop arm 28 is rotatable to a support position when the edge of the board is pushed against it.

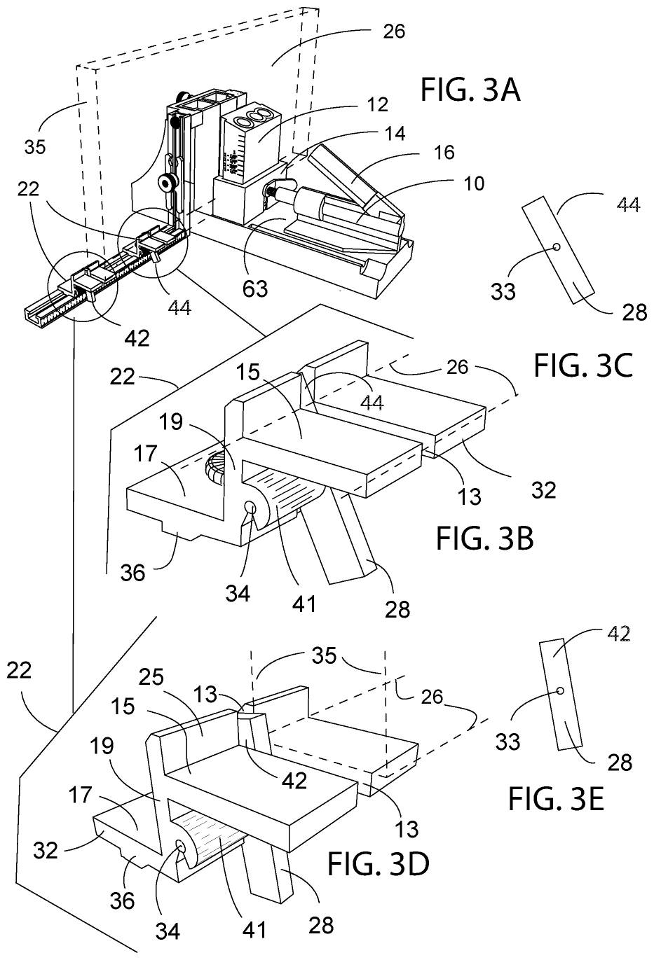

FIG. 3A is a perspective drawing of a KREG K4 pocket hole 10 with a workpiece panel 26 positioned for drilling. The view is shown from the clamp 16 side of the jig 10. The workpiece 26, which is illustrated with dotted lines, is supported by two example swing stop assemblies 22 shown secured to a T-slot track 20 and the floor 63 of the jig 10. The swing stop arm 28 nearest the KREG K4 pocket hole 10 is illustrated as having been urged or moved out of the way by the workpiece 26 and is in the stand-by or support position 44. The swing stop arm 28 that is the farthest from the KREG K4 pocket hole jig 10 is in the engaged or stop position 42, and is in contact with the end 35 of the workpiece 26. As illustrated, each of the swing stop assemblies 22 is capable of functioning as a full support (e.g., when the swing stop arm 28 is urged out of engagement) and as a stop (e.g., when the swing stop arm 28 is in its natural hanging orientation). In addition, the swing stop assemblies 22 also include a support surface that can be utilized simultaneously when the swing stop arm 28 is in the stop position. Furthermore, the swing stop assemblies 22 provide a generally planar extension of the floor 63 of the jig 10, such that a longer workpiece can be supported beyond the floor 63 of the jig 10 at desired locations and/or intervals.

Additional aspects of the example swing stop assembly 22 are illustrated in FIGS. 3B, 3C, 3D, and 3E. FIG. 3B is an enlargement of the FIG. 3A. The workpiece 26 is represented with a dotted line. FIG. 3B illustrates the swing stop assembly 22 nearest the jig 10 with the swing stop arm 28 moved out of the way by the workpiece 26 and located in the stand-by or support position 44. Specifically, the workpiece 26 is in contact with the fence 25 and the swing stop arm 28 is rotated into the opening or slot 13 in the middle 19 of the fence 25. FIG. 3C illustrates the swing stop arm 28 oriented in the stand-by position 44 at which the longitudinal axis of the swing stop arm 28 is further skewed relative to a vertical reference. FIG. 3D illustrates the swing stop assembly 22 shown in FIG. 3A furthest from the jig 10, with the workpiece 26 represented with a dotted line. The end 35 of the workpiece 26 is shown in contact with the swing stop arm 28, which is in the natural, engaged or stop position 42. FIG. 3E illustrates the swing stop 28 in the engaged position 44 at which the longitudinal axis of the swing stop arm 28 is closer to the vertical reference than when in the support or stand-by position shown in FIG. 3B.

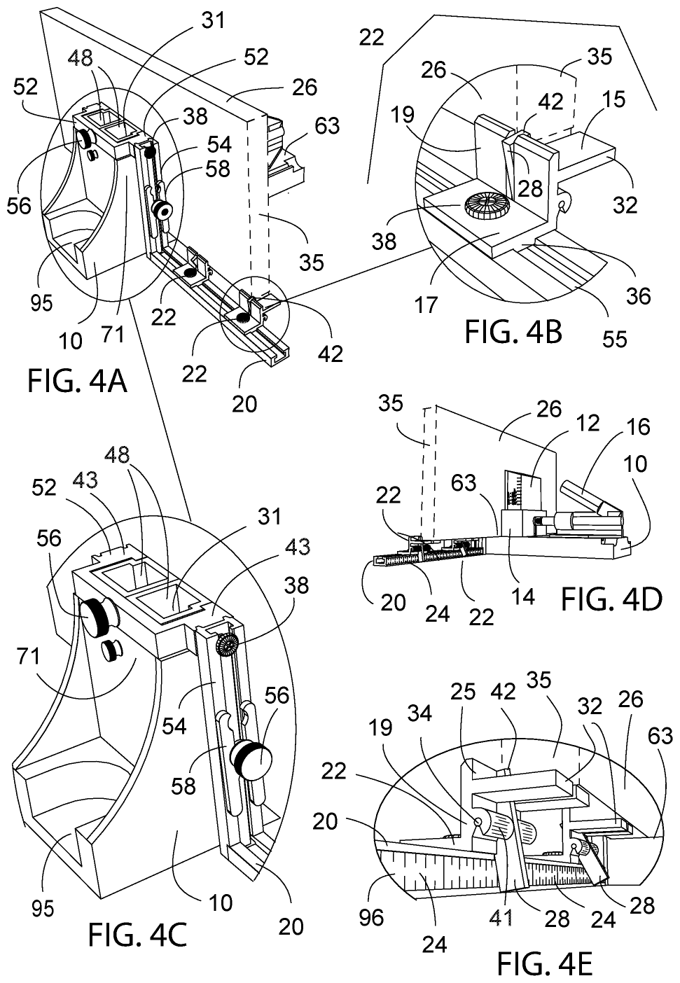

FIG. 4A is a perspective drawing of a KREG K4 pocket hole jog 10 with a workpiece panel 26 positioned for drilling a pocket hole. The workpiece 26 is supported by the floor 63 of the jig 10 and two example swing stop assemblies 22. The view is shown from the tower 71 side of the jig 10 opposite the fast action toggle clamp 16. The clamp pad 95 allows the KREG K4 pocket hole jig 10 to be clamped to a workbench top. The drill guide 12 has been removed from the drill guide comportment 31 inside the pocket hole jig tower 31. The dill guide compartment 31 contains two extruded spacers 48 that replace the drill guide 12. A U-shaped fixture 52 is positioned on top of the jig tower 71 and is secured to the KREG jig drill guide opening spacers 48 with a thumbscrew 56. Attached on one side of the U-shaped fixture 52 is vertically mounted, upright T-slot track 54, which is secured with a machine screw 38. Attached to the bottom of the T-slot vertical leg 54 is a ¾ inch by ⅜ inch T-slot extrusion 20. Mounted on the T-slot track 20 are two swing stop assemblies 22 that support the workpiece 26. The swing stop arm 28 of the swing stop assembly 22 shown in the foreground of the illustration is in the engaged stop position 42 and thus contacting the end 35 of the workpiece 26 represented with a dotted line. FIG. 4B is an enlargement of the swing stop assembly 22 shown in FIG. 4A. The swing stop arm 28 is positioned in the engaged stop position 42 in contact with the edge 35 of the workpiece board 26. The edge 35 of the workpiece board 35 is represented with a dotted line.

FIG. 4C is an enlargement view of FIG. 4A of the U-shaped clamp on fixture 52. Two spacers 48 are designed to replace the drill guide and fill the cavity of the drill guide compartment 31. A U-shaped fixture 52 is positioned on top of the jig tower 71 and is secured to the two spacers 48 that fill the cavity of the drill guide compartment 31. A T-slot extrusion 54 is secured to the end of the U-shaped clamp on fixture 52 with a machine screw 38. The vertical T-slot extrusion 54 has a flip stop arm 58 attached to the T-slot opening 55 with a thumb screw 56. Attached to the bottom of the vertical T-slot extrusion 54 is a ¾ inch by ⅜ inch T-slot extrusion 20.

FIG. 4D is a perspective drawing of a KREG K4 pocket hole 10 with a workpiece panel 26 positioned for drilling. The workpiece 26 is resting on the floor 63 of the pocket hole jig 10 and is supported by the two swing stop assemblies 22, which are secured to a T-slot track 20.

FIG. 4E is a perspective drawing from under the workpiece 26 supported by two swing stop assemblies 22 secured to a T-slot track 20. The bottom of the swing stop arms 28 line up with the ruler 24 located in the indentation 96 of the T-slot track 20. The location of the swing stop arm 28 can be determined by the position of the swing stop assembly 22 (e.g., the location of the swing stop arm 28). The vertical member 19 of the Z-shaped extrusion 32 incorporates a round ridge 41 that contains a small central hole 34 for receiving the round pin 50 illustrated in FIG. 1D. As discussed, a slot 13 in the middle 19 of the Z-shaped extrusion 32 is configured to accept the rectangular swing stop arm 28. The pin 50 pivotally couples the swing stop arm 28 to the Z-shaped extrusion 32 when the pin 50 extends through the hole 34 in the ridge 41 and the hole 33 in the swing stop arm 28. Again, one of the outside legs 15 of the Z-shaped extrusion 32 is configured to be substantially horizontal and parallel to the floor 63 of the pocket hole jig 10 such that it functionally establishes a planar extension of the floor 63 used to position and support a workpiece. In one embodiment, the middle leg 19 of the Z-shaped extrusion 32 extends past the horizontal surface 15 supporting the workpiece and functions as a fence 25 to position the workpiece 26 to be aligned with the drill guide block. In the example embodiment, the swing stop arm 28 is located in a centrally positioned slot 13 of the Z-shaped extrusion 32. And, in one form, approximately the top quarter of the swing stop arm 28 extends upward through the slot 13 in the middle of the Z-shaped extrusion 32 thereby extending thorough an imaginary plane bounded by the perimeter of the horizontal surface 15 through which the slot 13 intersects. The rectangular swing stop arm 28 functions as a position stop when the end of the board rests against it (e.g., in a direction generally along the axis of rotation of the swing stop arm 28) and rotates from a resting position when the edge of the board is pushed against it (e.g., in a direction generally skewed to the axis of rotation of the swing stop 28).

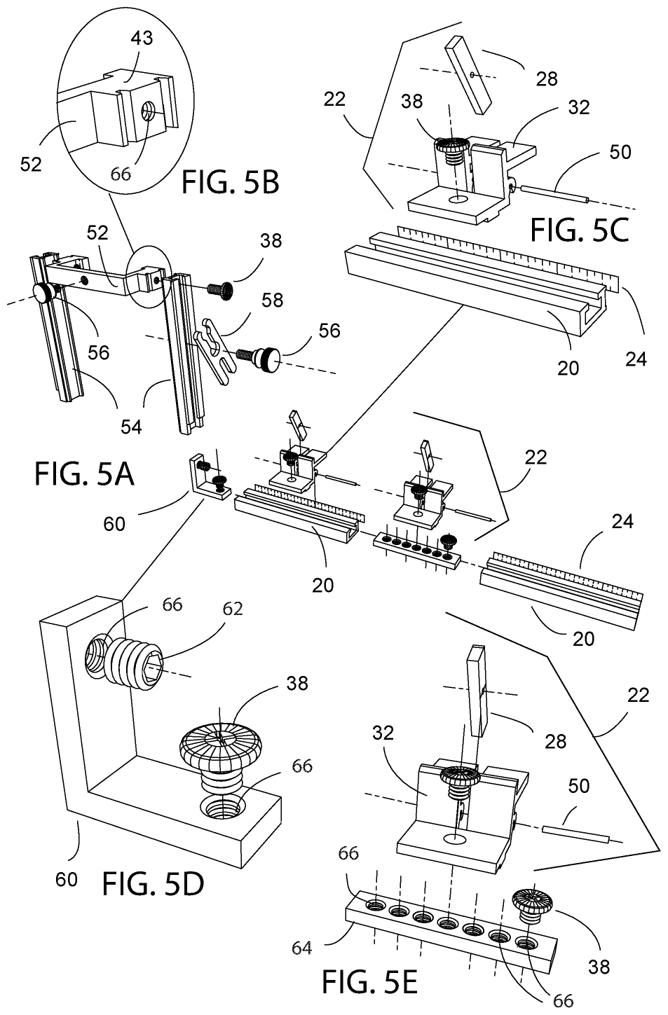

FIG. 5A is an exploded view of the example U-shaped clamping fixture 52, the vertical T-slot legs 54, the L-shaped connector 60, the T-slot extrusion track 20, the extrusion connector 64, an exploded views of the example swing stop assemblies 22. The view is shown from the closed side of the U-shaped extrusion 52. FIG. 5B is an enlarged view of the end flange 43 of the U-shaped extrusion 52 illustrating the threaded hole 66 configured to receive the machine screw 38 to secure the vertical T-slot track 54 at a desired position. FIG. 5C is an exploded view of the T-slot extrusion track 20, the ruler 24, and the exploded swing stop assembly 22. The swing stop assembly 22 includes the example Z-shaped base extrusion 32 and the example rectangular swing stop arm 28, with the swing stop arm 28 being pivotally coupled to the Z-shaped base extrusion 32 via the pin 50. FIG. 5D is an enlarged view of the L-shaped connector 60 that fits into the vertical T-slot leg 54 and the horizontal track 20, thus selectively coupling the components. Drilled and tapped holes 66 in each leg allow the L-shaped connector to be selectively locked into or secured to the track (e.g., T-slot track 54 and T-slot extrusion track 20) with a setscrew 62 or a machine screw 38. FIG. 5E is an enlarged view of the rectangular shaped extrusion connector plate 64 that fits into the T-slot track 20. Multiple drilled and tapped holes 66 allow two T-slot extrusions 20 to be coupled together, thus further extending the available placement of the swing stop assemblies 22 and, as a result, the effective support and stop capabilities.

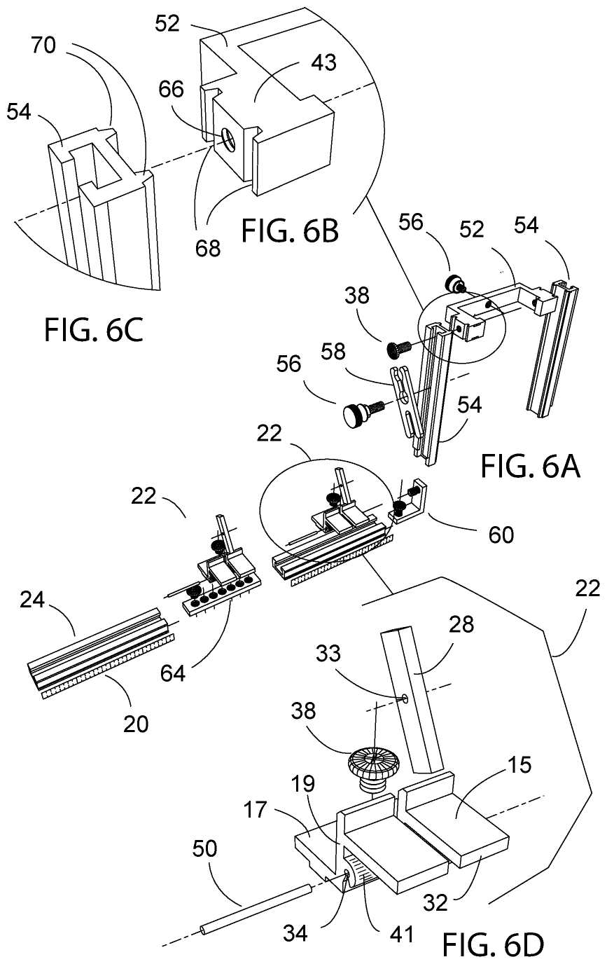

FIG. 6A, which is similar to FIG. 5A but from the opposite side of the U-shaped fixture 52, is an exploded view of the U-shaped clamping fixture 52, the vertical T-slot leg 54, the L-shaped connector 60, the T-slot extrusion track 20, the extrusion connector 64, and exploded views of the example swing stop assemblies 22. FIG. 6B is an enlarged view of the rectangular U-shaped extrusion 52 illustrating two U-shaped grooves 68 on each side of a threaded hole 66. FIG. 6C is an enlarged view of the end of the T-slot track 54 illustrating two U-shaped ridges 70 on the track 54 opposite the T-slot opening. The two U-shaped ridges 70 are configured to mate with the U-shaped grooves 68 illustrated in FIG. 6B. FIG. 6D is an exploded view of the example swing stop assembly 22, described throughout, that fits into the T-slot track 20 shown in FIG. 6A.

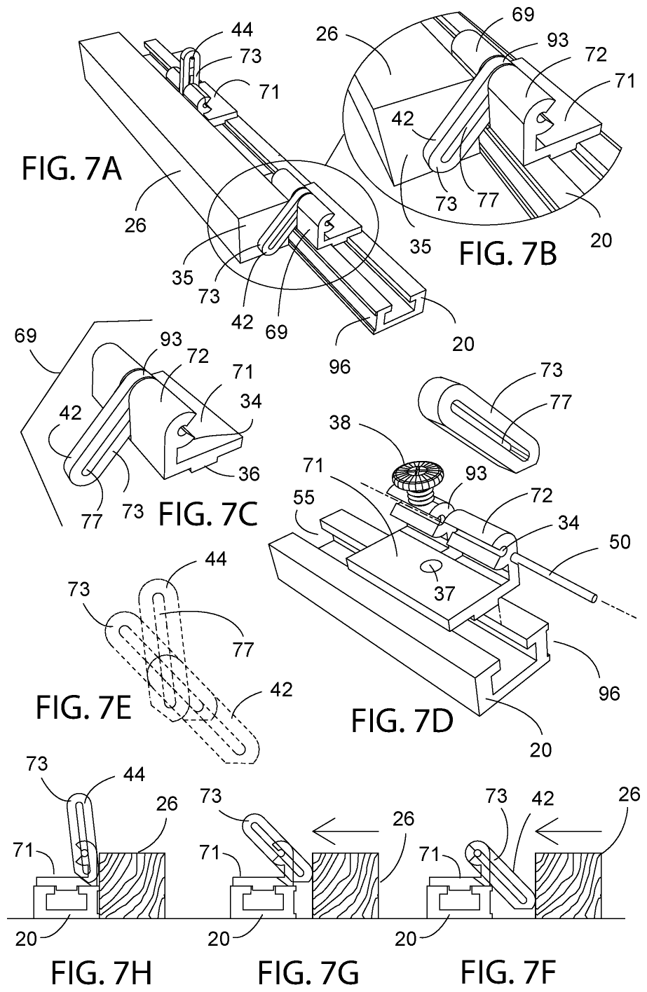

An example embodiment of a slide stop assembly is illustrated in FIGS. 7A-7H. Given the benefit of this disclosure, one skilled in the art will appreciate the various alterations and modifications to the slide stop assembly concept that fall within the scope of the invention.

FIG. 7A is a perspective drawing of a T-slot track 20 with two example slide stop assemblies 69 secured to the T-slot track 20 via a stop base 71. The stop base 71 is L-shaped with a rectangular elevation 36 that fits into the T-slot 20. A workpiece 26 is in contact with the T-slot track extrusion 20. The slide stop assembly 69 in the background of the drawing has a slide stop arm 73 moved to the stand-by or disengaged positon 44 by engagement with the workpiece 26. The slide stop assembly 69 in the foreground of the drawing has a slide stop arm 73 shown in the engaged or stop position 42 with the end 35 of the workpiece 26. FIG. 7B is an enlarged view of the slide stop assembly 69 shown in FIG. 7A. The stop base 71 is L-shaped, with the short leg of the stop base 71 extrusion having an enlarged round shape 72 with a small slotted hole 34 inside the middle of the circular profile defined by the round shape 72. A groove or slot 93 in the middle of the short leg of the stop base 71 is fitted with an oblong-shaped slide stop arm 73. The oblong-shaped slide stop arm 73 has an oblong-shaped slot 77 generally centralized along a longitudinal axis of the slide stop arm 73. The side of the slide stop arm 73 can be in contact with the end 35 of a workpiece 26, such as the slide stop assembly 69 shown in the foreground of FIG. 7A.

FIG. 7C is a view of FIG. 7B with the slide stop assembly 69 removed from the T-slot track 20. FIG. 7D is an exploded view of FIG. 7A illustrating the small round rod 50 that fits into the small hole 34 and through the oblong-shaped slot 77 of the slide stop arm 73, thus pivotally and slideably coupling the slide stop arm 73 to the stop base 71. As such, the slide stop arm 73 can both rotate about the axis of the pin 50 and slide along the pin 50 over the length of the slot 77. FIG. 7E is an illustration of three example positions or orientations of the slide stop arm 73 as the slide stop arm 73 transitions between a support position and a stop position, represented with dotted lines.

FIGS. 7F-7H further illustrate the example transition between a stop position (shown in FIG. 7F) and a stand-by position (shown in FIG. 7H). Beginning at FIG. 7F, the slide stop arm 73 is in the full stop position with the pin 50 at the upper leftmost end of the slot 77, such that the slide stop arm 73 is urged downward by gravity to the orientation shown resting on the T-slot track 20. As the workpiece 26 is urged left toward and into the slide stop arm 73, and toward the T-slot track 20, the slide stop arm 73 is urged upward and leftward as the slot 77 and pin 50 interact at the interface there between. In FIG. 7G, the slide stop arm 73 is oriented at about a 45 degree angle. FIG. 7G further illustrates the workpiece 26 moving the oval slide stop arm 73 onto the T-slot track extrusion 20. As the workpiece 26 continues to urge the slide stop arm 73 to generally leftward, the slot 77 of the slide stop arm 73 continues to interact with the pin 50, such that the slide stop arm 73 moves toward an generally vertically orientation as illustrated in FIG. 7H to rest atop the T-slot track 20. FIG. 7H is an illustration of the workpiece 26 moved to abut the T-slot track extrusion 20. As shown, the angled end portion of the slide stop arm 73 is resting near or on the T-slot track 20 and the opposite end of the slide stop arm 73 is raised, resulting in the slide stop arm 73 being in the stand-by position and not functioning as a stop.

The example embodiment of the slide stop assembly 69 can be adapted to accommodate various application requirements. For instance, the slot 93 can be located off center of the stop base 71, and the slide stop arm 73 and slot 77 may be of varying lengths, dimensions, and relative positions.

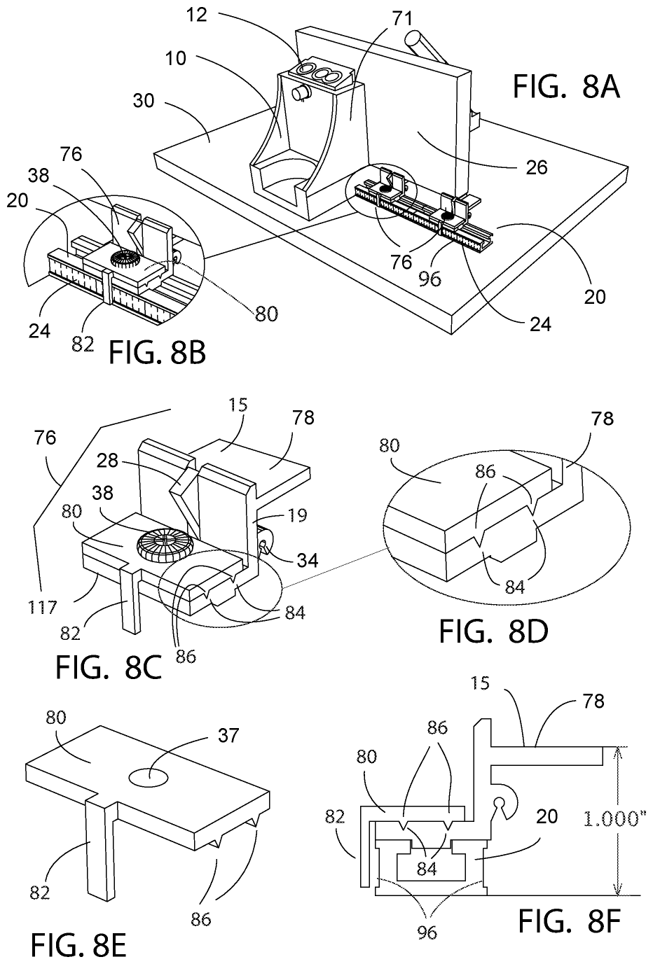

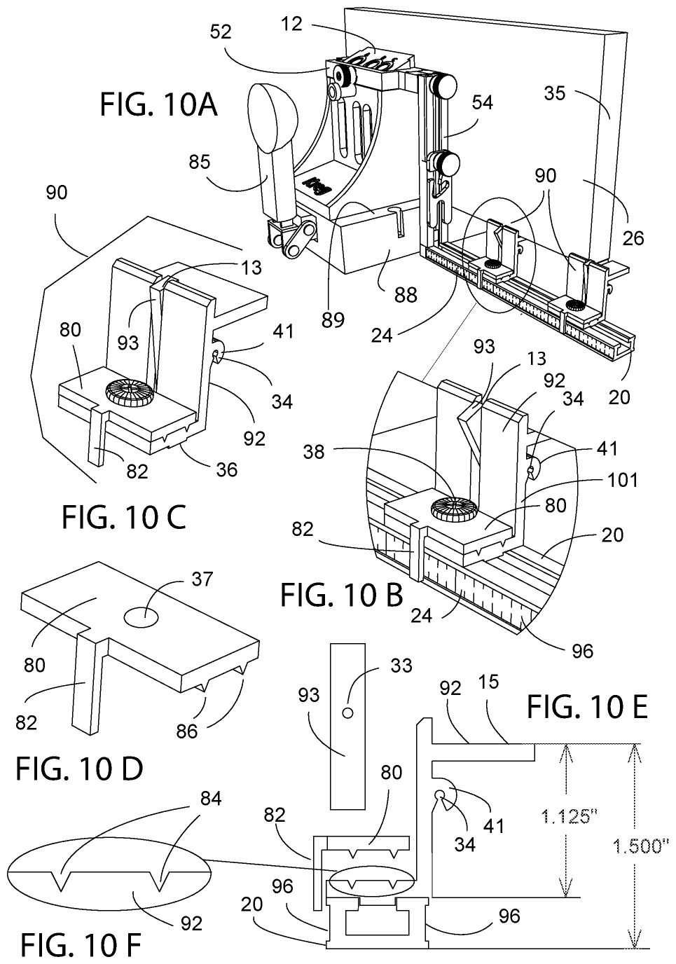

Various alterations and modifications can be made to the example stop assemblies. For instance, FIG. 8E illustrates an example cursor plate 80 and FIG. 10E illustrates an example swing stop extrusion 92 that can be adapted for use with a variety of stop assemblies.

FIG. 8A is a perspective drawing of a KREG K4 pocket hole jig 10 secured to a flat board 30. The panel is between the drill guide block and the fast action clamp securing the workpiece panel. Attached to the flat board 30 is a ¾ inch by ⅜ inch horizontal T-slot extrusion 20 that has an indentation 96 for a ruler 24. Attached to the extrusion 20 are two example swing stop assemblies 76, which support the bottom of the workpiece 26. The swing stop assemblies 76 are generally similar to the swing stop assemblies 22 described in detail above, with the addition of an example cursor plate 80, for instance. The swing stop assembly 76 includes a short Z-shaped extrusion 78 with a small hole or slot 13 in the middle leg 19. The slot 13 in the middle of the Z-shaped extrusion 78 is configured to accept a rectangular swing stop arm 28. A pin 50 located in the small slotted hole 34 of the Z-shaped extrusion 82 extends through a hole 33 in the rectangular swing stop arm 28, similar to that described above in connection with swing stop assembly 22.

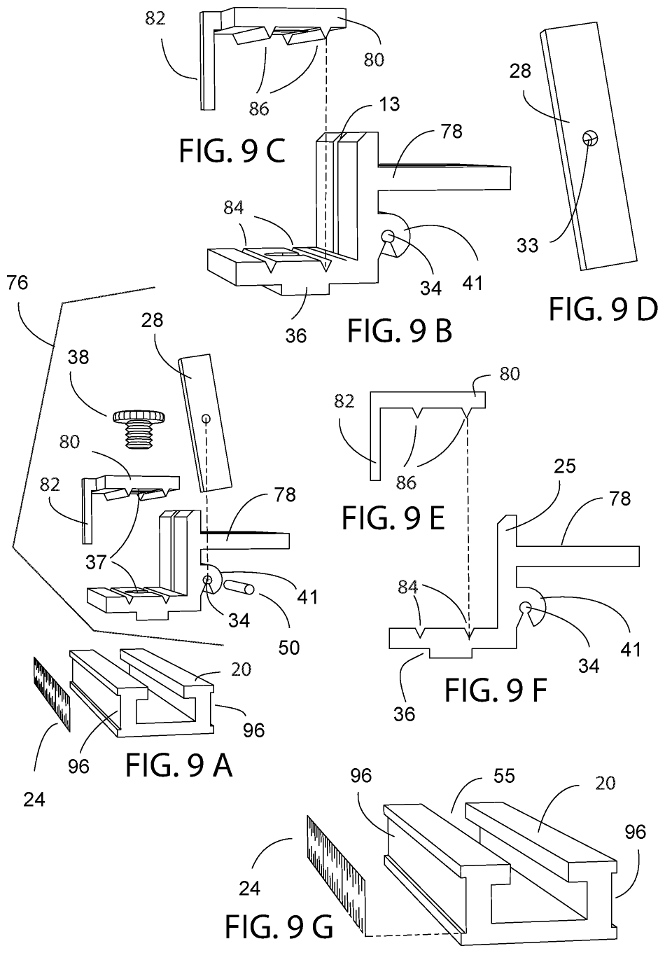

FIG. 8B is an enlargement of the swing stop assembly 76 shown in FIG. 8A. A cursor 82 on the cursor plate 80 lines up with the swing stop arm 28, allowing the relative location of the swing stop arm 28 to be determined via the ruler 24. In one example, aligned with the nominally 0.125 inch wide swing stop arm 28 is a rectangular, nominally 0.125 inch wide cursor 82 positioned in front of the ruler 24. As before, one of the outside legs 15 of the Z-shaped extrusion 78 is configured to be horizontal and parallel to the floor of the pocket hole jig 10 and is further positioned to support a workpiece board 26. The middle leg 19 of the Z-shaped base extrusion 78 extends upward past the horizontal surface 15 supporting the workpiece 26 and functions as a fence 25 (see FIG. 9F) to position the workpiece 26 to be aligned with the drill guide block. Again, as described in detail above, approximately the top quarter of the swing stop arm 28 may be configured to extend upward through the slot 13 in the middle of the Z-shaped base extrusion 78. The swing stop arm 28 can again be urged from a natural, resting stop position to a support position at which the swing stop arm 28 is not encroaching on the imaginary plane bounded by the perimeter of the horizontal surface 15. The rectangular swing stop arm 28 functions as a position stop when the end of the board rests against it. And, it can be rotated to a stand-by position when the edge of the board is moved against it pushing it out of the way.

FIG. 8C is an enlargement of FIG. 8B with the example swing stop assembly 76 removed from the T-slot track 20. This illustration shows the cursor plate 80 that is located between the Z-shaped swing arm base 78 and the machine screw 38. In the middle of the rectangular cursor plate 80 is a narrow leg that functions as a cursor 82 in front of the ruler 24. The cursor plate 80 is shown in detail in FIG. 8E. In some embodiments, the cursor 82 and the swing stop arm 28 line up with each other and are both about 0.125 inches wide. Two V-shaped ridges 86 are located on the bottom of the cursor plate 80 and mate with the V-shaped grooves 84 on the top of the Z-shaped swing arm base 78. FIG. 8D is an enlarged perspective view of FIG. 8C illustrating the Z-shaped swing arm base 78 in contact with the cursor plate 80. The V-shaped ridges 86 and V-shaped grooves 84 help to position and restrain the cursor plate 80 and the swing arm base 78 when the machine screw 38 is installed.

FIG. 8F is an end view of the example swing stop arm base 78 positioned on the rectangular T-slot extrusion 20. In some forms, the distance between the bottom of the T-slot track 20 and the top of the swing stop assembly support floor (e.g., horizontal surface 15) is nominally 1-inch, which is the same as the height of floor 63 of the KREG K4 jig 10 (see, for instance, FIG. 1A). This configuration allows the example swing stop assembly 76 (and, for instance, the swing stop assembly 22) to be arranged to provide a generally planar and level imaginary floor with swing stop assemblies that are placed select and desired distances from a jig or other woodworking machine/fixture/device.

FIGS. 9A-9G are various views of the example swing stop assembly 76, which includes the Z-shaped base extrusion 78, the cursor plate 80, the swing stop arm 28, the tightening screw 38, and the retention rod or pin 50, and the T-slot track extrusion 20 with the ruler 24. In particular, FIG. 9E is an end view of the cursor plate 80 and FIG. 9F is an end view of the Z-shaped swing stop base extrusion 78, which are configured to mate, as described above. FIG. 9G is an enlarged view of the example stick-on tape measure 24 and the T-slot track extrusion 20 with an indentation 96 on both sides for accepting a stick-on tape measure 24. In other forms, the measurement indicators may be printed, engraved, or similarly associated with the structure of the T-slot track 20.

Given the benefit of this disclosure, one skill in the art will appreciate the various alternatives and constructions of, for instance, the cursor plate 80. For example, the cursor 82 can be tapered or rounded. In still other forms, the cursor plate 80 may include one or more cursors. In some embodiments, the cursor plate 80 and the Z-shaped base 78 may be integral (e.g., such as if injection molded as a single component).

The example embodiments described herein can be adapted to accommodate the form factor and dimensions of various woodworking devices. For instance, as described below, the dimensions of the example swing stop assembly 90 can be modified to accommodate the relative dimensions KREG K5 pocket hole jig 88 and the raised work surface floor 89 that it defines. FIG. 10A is a perspective drawing of a KREG K5 pocket hole jig 88. A U-shaped fixture 52 is positioned on top of the jig 88 and is secured to the movable drill guide 12. Attached to the U-shaped fixture 52 is a vertical T-slot leg 54 that extends vertically from the top of the U-shaped fixture 52 down to the bottom of the pocket hole jig body 88. Attached to the bottom of the T-slot leg is a ¾ inch by ⅜ inch T-slot track extrusion 20. Attached to the extrusion are two example swing stop assemblies 90, which consist of a short Z-shaped base extrusion 92 with a small hole 34 in the middle vertical leg 101. A slot 13 in the middle of the Z-shaped base extrusion 92 accepts a rectangular stop arm 93. The workpiece panel 26 is illustrated with a solid line.

The example swing stop assemblies 90 are similar to the example swing stop assemblies 76 described above, with the middle vertical leg 101 being longer to accommodate the raised floor 89 of the jig 89. FIG. 10B is an enlargement of the swing stop assembly 90 shown in FIG. 10A. Aligned with the example 0.125 inch wide swing stop arm 93 is a rectangular approximately 0.125 wide cursor 82 positioned in front of the ruler 24. FIG. 10C is an enlargement of the swing stop assembly 90 shown in FIG. 10A removed from the T-slot track 20. The Z-shaped swing stop base 92 is longer to accommodate the higher floor of the KREG K5 pocket hole jig and, for instance, the ARMOR pocket hole jig. FIG. 10D is a stand-alone perspective drawing of the cursor plate 80 illustrated in FIG. 10C. Again, and with reference to FIG. 10E and FIG. 10F, two V-shaped ridges 86 are located on the bottom of the cursor plate 80. FIG. 10E is an end view of the T-slot track extrusion 20 with the Z-shaped stop base extrusion 92 in contact with it. The cursor plate 80 is shown spaced apart from the Z-shaped swing stop base extrusion 92. FIG. 10F is an enlarged side view showing the V-grooves 84 of the Z-shaped swing stop extrusion 92. The distance between the bottom of the T-slot track extrusion and the floor (e.g., a horizontal surface 15) of the swing stop support platform is 1.5 inches, which is nominally the height of floor 89 defined by the KREG K5 jig 88 and the ARMOR pocket hole jig.

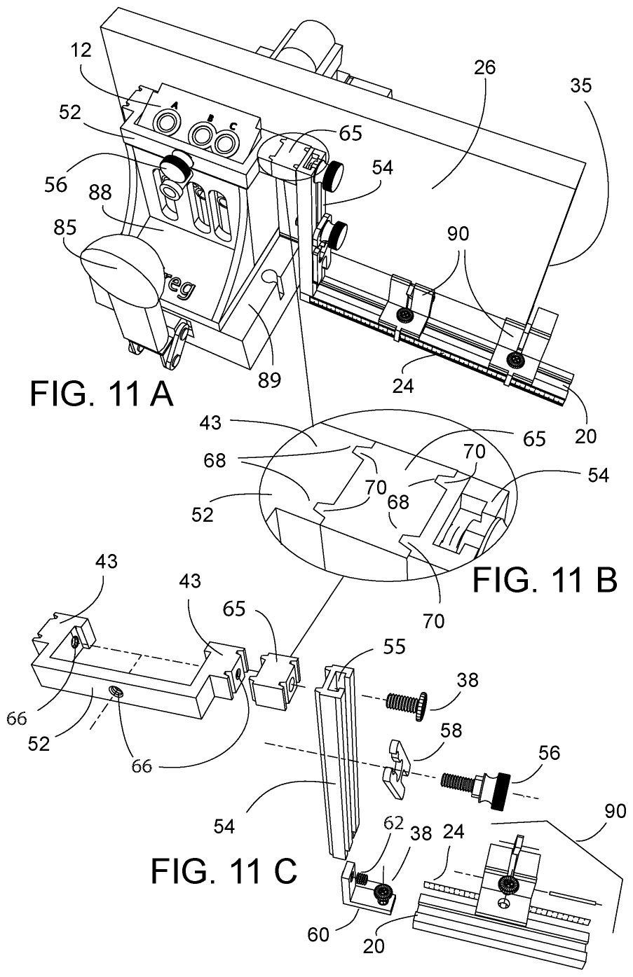

FIG. 11A is a perspective drawing of a KREG K5 pocket hole jig 88 with a clamp on swing stop positioning system featuring two example swing stop assemblies 90, which support the workpiece panel 26 at approximately the same height as the jig floor 89, while also providing an adjustable swing stop for repeatedly locating the end of the workpiece in relationship to the drill guide 12. The view is shown from the drill guide 12 side of the KREG K5 jig 88. The swing stop assemblies 90 have been described above in detail.

FIG. 11B is an enlargement of FIG. 11A illustrating a spacer 65 that is located between the U-shaped fixture 52 and the vertical T-slot track 54 that extends to the bottom of the pocket hole jig 88. The solid rectangular spacer 65 is approximately the same dimension in thickness as the U-shaped fixture 52. The spacer 65 expands the width of the U-shaped fixture 52 to accommodate the extra width of the KREG K5 jig 88 in comparison to the KREG K4 jig 10. The U-shaped fixture 52 has two U-shaped grooves 68 to accurately position and secure accessories. The spacer 65 has two matching U-shaped elevations 70 on one side and two matching U-grooves 68 on the opposite side to accurately fit between the U-shaped fixture 52 and the modified T-track 54. FIG. 11C is an exploded view of the U-shaped clamping fixture 52, the spacer 65, the vertical T-slot leg 54, the L-shaped connector 60, the T-slot extrusion track 20, and exploded view of the example swing stop assemblies 90.

Preferred embodiments of the invention have been described in considerable detail. Many modifications and variations to the preferred embodiment described will be apparent to a person of ordinary skill in the art. While various components have been described as distinct parts of an assembly, in alternative forms, select components can be formed as a single unit. In addition, while many of the components are described as metallic (e.g., aluminum) that are made via extrusion and secondary machining operations, the components may be comprised of other materials, such as plastics and composites, and/or manufactured to a final or near final form factor. Therefore, the invention should not be limited to the embodiment described.

1. A swing stop assembly, comprising:
a base having a support surface, the support surface defining a support surface area and a support surface width in a first direction; and
a swing stop arm pivotally coupled to the base and defining an arm width in the first diction;
wherein the arm width is less than the base width; and
wherein the swing stop is configured to pivot between a stop position at which at least a portion of the swing stop extends through the support surface area and a support position at which the swing stop does not extend through the support surface area.

2. The swing stop assembly of claim 1, wherein the swing stop arm is rectangular.

3. The swing stop assembly of claim 1, wherein the swing stop arm is pivotally coupled to the base by a pin engaged with an opening in the swing stop arm and a receiving opening in the base.

4. The swing stop assembly of claim 3, wherein the opening in the swing stop arm is located above a longitudinal midpoint of the swing stop arm.

6. The swing stop assembly of claim 1, wherein the base defines a slot into which the swing stop arm is seated within when in both the stop position and the support position.

7. The swing stop assembly of claim 1, wherein the base defines a slot that bisects the support surface in the first direction such that the support surface comprises two discrete surfaces bounded by a perimeter.

8. A slide stop assembly, comprising:
a base; and
a slide arm defining a slot along a longitudinal dimension of the slide arm;
wherein the slide arm is pivotally and slideably coupled to the base by a pin coupled to the base and positioned at an interface with the slot of the slide arm;
wherein the interface between the pin and the slot defines an engaged position and a disengaged position.
